(19) United States
(12) Patent Application Publication
(10) Pub. No.: US 2012/0006264 A1
(43) Pub. Date: Jan. 12, 2012

(54) FILM FORMATION APPARATUS

(75) Inventors: Nobutaka Ukigaya, Mobara-shi (JP); Takehiko Soda, Yokohama-shi (JP); Masataka Eida, Toride-shi (JP); Kazushi Miyata, Mobara-shi (JP); Yoshihiro Kawaguchi, Mobara-shi (JP); Shouichi Noda, Mobara-shi (JP)

(73) Assignees: Hitachi Displays, Ltd., Mobara-shi (JP); CANON KABUSHIKI KAISHA, Tokyo (JP)

(21) Appl. No.: 13/156,900

(22) Filed: Jun. 9, 2011

(30) Foreign Application Priority Data
Jul. 6, 2010 (JP) 2010-153692
Jun. 7, 2011 (JP) 2011-126928

(51) Int. Cl. B05C 11/00

(52) U.S. Cl. 118/713

(57) ABSTRACT

Provided is a film formation apparatus capable of reducing vibration and deformation that may be transmitted to an alignment mechanism and thereby suppressing misalignment between a substrate and a mask in a surface direction. The film formation apparatus includes: a film forming chamber; a supporting member; and an alignment mechanism provided on the supporting member in which: the supporting member includes a supporting plate for placing the alignment mechanism, and a leg portion; the supporting plate is provided so as to be spaced apart from a top board of the film forming chamber via the leg portion; and at least a part of the supporting plate is formed of a damping material capable of converting vibration transmitted to the supporting plate into thermal energy, thereby suppressing the vibration.

### BACKGROUND OF THE INVENTION

1. Field of the Invention

The present invention relates to a film formation apparatus.

2. Description of the Related Art

Conventionally, as a method of manufacturing an organic electroluminescence (EL) apparatus, there is widely employed a mask film formation method in which a film formation mask is arranged in close contact with a substrate. An example of the mask film formation method is a mask vapor deposition method. When the mask vapor deposition method is employed, an organic compound layer, which constitutes the organic EL apparatus, can be patterned at a predetermined position with high precision during the formation by a vapor deposition method or a sublimation method.

In recent years, the development of high-resolution organic EL apparatus has led to still finer patterning. For example, in an organic EL display apparatus, the sizes of sub-pixels of red, green, and blue which are repeatedly arranged on a display surface of the substrate have become finer, and it is therefore required to pattern a red light emitting layer in a red pixel with higher positional precision. If the position of film formation of the red light emitting layer is deviated from a predetermined position in a surface direction, a part of the red light emitting layer is formed in a sub-pixel of green or blue, which is disposed adjacent thereto. This causes a display defect such as a defect of mixed color. In other words, slight misalignment between a pixel pattern disposed on the substrate and an aperture pattern of the film formation mask may degrade quality of the organic EL apparatus.

Meanwhile, as illustrated in FIG. 5, an alignment mechanism 30 installed in a conventional film formation apparatus 100, which includes cameras 32, a drive mechanism 31, and the like for performing alignment between a substrate 11 and a film formation mask 13, is placed on a top board 10a of the film formation apparatus 100. Therefore, it is known that, if the side wall including the ceiling of a film forming chamber 10 is deformed by a pressure difference between inside and outside the film formation apparatus, distortion is generated in the alignment mechanism 30 to easily cause misalignment between the substrate 11 and the mask 13. Note that, the distortion of the alignment mechanism as described herein means, for example, deviation of the optical axis of the camera for alignment or degradation in repeatability of the operation position of a substrate supporting member. If such distortion is generated in the alignment mechanism, the precision of alignment between the substrate and the film formation mask is lowered to increase the risk of trouble directly leading to the above-mentioned degradation in quality of the organic EL apparatus. Note that, the substrate supporting member is represented by reference numeral 12 and a mask supporting member is represented by reference numeral 14.

In order to solve the above-mentioned problem of misalignment accompanying the pressure difference between inside and outside the film formation apparatus, Japanese Patent Application Laid-Open No. 2005-248249 proposes the film formation apparatus having the apparatus configuration in which the alignment mechanism for performing alignment between the substrate and the mask is disposed on the supporting plate which is directly fixed in proximity to the top board of the film formation apparatus (vacuum chamber). With this configuration, the deformation of the top board caused by the pressure difference between inside and outside the film formation apparatus is transmitted indirectly to the alignment mechanism via the supporting plate, and hence the influence of the deformation of the top board on the operation of the alignment mechanism can be alleviated.

However, misalignment between the substrate and the mask may occur also by vibration transmitted to the alignment mechanism. An issue of particular concern is that the precision of alignment between the substrate and the mask is affected when vibration generated by peripheral apparatus installed outside the film formation apparatus and the like or vibration accompanying the operation of a transfer robot or the contact or collision operation of respective components provided inside the film formation apparatus is transmitted to the alignment mechanism.

For example, when vibration having an acceleration of 0.1 to 1.0 mm/s² is applied to the mask, the substrate, or the support structure therefor, the relative positions of the mask and the substrate may be offset by approximately 0.1 to 10 μm. The allowable range of alignment precision for a high-definition and high-resolution organic EL apparatus is 1 to 20 μm, preferably 1 to 10 μm. Therefore, the above-mentioned degree of offset caused by the vibration corresponds to a fatal degree. For example, in an organic EL display apparatus having a 3-inch display area, the size of pixels for VGA resolution is approximately 96 μm. In this display apparatus, when the area ratio (pixel aperture ratio) of a light emitting region is 25%, the positional precision corresponds to half the width of approximately 20 μm of a non-light emitting region between the light emitting regions. Note that, the above-mentioned acceleration of the vibration is not an especially large acceleration but an acceleration that is generated in a normal up-and-down operation of the mask supporting mechanism installed in our own organic EL vapor deposition apparatus. However, the value described above may vary depending on the form of the apparatus and the operation conditions of the structure of the apparatus, including moving speed and acceleration.

In the configuration described in Japanese Patent Application Laid-Open No. 2005-248249, the top board of the film formation apparatus and the supporting plate are directly fixed to each other in an integrated manner, and hence there is a fear that the vibration generated inside or outside the film formation apparatus is transmitted to the alignment mechanism via the top board of the film forming chamber and the supporting plate fixed to the top board. Further, there is another fear that, depending on the position at which the top board of the film formation apparatus and the supporting plate are fixed, slight deformation generated in the film forming chamber as well as the vibration is transmitted to the alignment mechanism via the supporting plate. As a result, the precision of alignment between the substrate and the film formation mask is lowered by the vibration or the deformation transmitted to the alignment mechanism, and hence the risk of trouble directly leading to the degradation in quality of the organic EL apparatus is increased.

### SUMMARY OF THE INVENTION

The present invention has been made in view of the above-mentioned problems, and therefore has an object to provide a film formation apparatus capable of reducing vibration and deformation that may be transmitted to an alignment mechanism for performing alignment between a substrate and a film formation mask in the film formation apparatus and thereby suppressing misalignment therebetween.

A film formation apparatus according to the present invention includes: a film forming chamber provided with a substrate supporting member and a mask supporting member in the film forming chamber; a supporting member provided outside the film forming chamber; and an alignment mechanism provided on the supporting member and provided with at least one of a position adjusting unit for the substrate supporting member and a position adjusting unit for the mask supporting member, and a camera for alignment, wherein: the supporting member includes a supporting plate for placing the alignment mechanism, and a leg portion; the supporting plate is provided so as to be spaced apart from a top board of the film forming chamber via the leg portion; and at least a part of the supporting plate is formed of a damping material capable of converting vibration transmitted to the supporting plate into thermal energy, thereby suppressing the vibration.

According to the present invention, at least a part of the supporting plate is formed of the damping material capable of converting vibration transmitted to the supporting plate into thermal energy, thereby suppressing the vibration. Hence, the present invention can provide a film formation apparatus capable of reducing vibration and deformation that may be transmitted to the alignment mechanism provided to the film formation apparatus, thereby suppressing misalignment between the substrate and the film formation mask. Therefore, by using the film formation apparatus according to the present invention, it is possible to manufacture an organic EL element and an organic EL apparatus in which an organic compound layer is patterned with less misalignment in a surface direction from a pixel pattern disposed on the substrate and with good dimensional precision.

Specifically, the level of positional precision that can be increased in the alignment step can be increased, and the positional precision at the stage of the alignment step can be made substantially equal to the positional precision of the pattern formed after the vapor deposition step.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a first embodiment of a film formation apparatus according to the present invention.

FIG. 2 is a schematic cross-sectional view illustrating a second embodiment of the film formation apparatus according to the present invention.

FIGS. 3A and 3B are schematic top views illustrating an example of arrangement of leg portions in the film formation apparatus according to the present invention.

FIG. 4 is a schematic cross-sectional view illustrating a third embodiment of the film formation apparatus according to the present invention.

FIG. 5 is a schematic cross-sectional view illustrating a film formation apparatus (conventional example) used in Comparative Example 1.

### DESCRIPTION OF THE EMBODIMENTS

A film formation apparatus according to the present invention includes a film forming chamber, a supporting member disposed outside the film forming chamber, and an alignment mechanism. The supporting member includes a supporting plate and leg portion. The alignment mechanism is provided on the supporting plate. Owing to the provision of the leg portion of the supporting member, even if the film forming chamber is deformed or vibrated by a pressure difference between inside and outside the film forming chamber under a reduced-pressure atmosphere, the supporting plate and a top board of the film forming chamber can securely be spaced apart from each other. Further, the leg portion included in the supporting member is provided in the vicinity of the periphery of the film formation apparatus. This configuration can effectively reduce misalignment between a substrate and a film formation mask accompanying the deformation of the top board of the film forming chamber. Here, the alignment mechanism includes at least one of a position adjusting unit for substrate supporting members and a position adjusting unit for mask supporting members, and cameras for alignment. Further, at least a part of the supporting plate for supporting the alignment mechanism is formed of a damping material capable of converting vibration transmitted to the supporting plate into thermal energy, thereby suppressing the vibration. Note that, at least the substrate supporting member and the mask supporting member are provided inside the film forming chamber. Further, a vapor depositing source for film formation is disposed inside the film forming chamber.

Hereinafter, referring to the accompanying drawings, the film formation apparatus according to the present invention is described in detail.

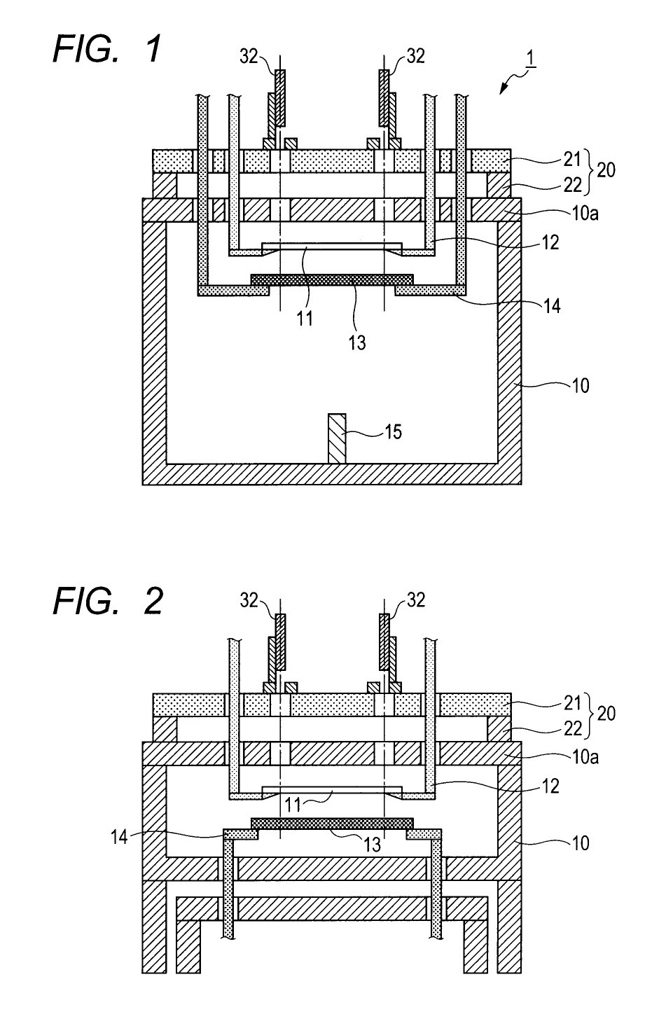

FIG. 1 is a schematic cross-sectional view illustrating a first embodiment of the film formation apparatus according to the present invention. Note that, a film formation apparatus 1 of FIG. 1 is used as, for example, a film formation apparatus for use in manufacturing an organic EL display apparatus.

A film forming chamber 10, which is a constituent member of the film formation apparatus of FIG. 1, includes, inside the chamber, substrate supporting members 12 for supporting a substrate 11, mask supporting members 14 for supporting a mask 13, and a vapor depositing source 15 for evaporating an organic material. The substrate supporting members 12 and the mask supporting members 14 provided inside the film forming chamber 10 are coupled to an alignment mechanism, which is provided outside the film forming chamber 10, via a vacuum seal member (not shown) such as a bellows. Further, a viewport is provided on the optical axis of a camera for alignment (in the direction of the broken line of FIG. 1). With this configuration, even when the substrate supporting members 12 or the mask supporting members 14 are moved, air-tightness inside the film forming chamber 10 can be maintained so as to maintain a constant pressure inside the film forming chamber 10.

The mask 13 supported by the mask supporting members 14 has a thin plate-like shape, which partially or entirely has an aperture. In a vapor deposition step which requires a finer pattern, it is suitable to set a thickness of a mask portion to 100 μm or less, and preferably, 50 μm or less.

As a material of the mask 13, metal materials such as copper, nickel, and stainless steel may be used. Instead of those metal materials, the mask portion may be fabricated by electroforming using a nickel alloy such as a nickel-cobalt alloy, an invar material made of a nickel-iron alloy, or a super invar material made of a nickel-iron-cobalt alloy. In particular, the invar material and the super-invar material each have a thermal expansion coefficient of 0.5×10⁻⁶ to 2×10⁻⁶/° C., which is smaller than those of the other metals, and thus the deformation of the mask due to the thermal expansion at the time of vapor deposition may be prevented.

Moreover, it is difficult to realize sufficient dimensional precision of the aperture over a large region for the mask for a large-size substrate. Therefore, it is also suitable to fabricate a frame member having high strength by using the invar material and to form a thin mask on a region surrounded by the frame member.

As the substrate 11 supported by the substrate supporting members 12, a silicon substrate, a glass substrate, or a plastic substrate may be used according to the intended use. For a large-size display, a substrate obtained by forming a drive circuit or a pixel electrode in advance on non-alkali glass is preferably used.

A supporting member 20, which is a constituent member of the film formation apparatus of FIG. 1, includes a supporting plate 21 for placing the alignment mechanism to be described later and leg portions 22 for grounding the supporting member 20. Note that, the positions at which the supporting plate 21 and the leg portions 22 are placed are described later.

The alignment mechanism, which is a constituent member of the film formation apparatus of FIG. 1, includes cameras for alignment 32 for checking the planar positions of the substrate 11 and the mask 13. Note that, although not illustrated, the alignment mechanism illustrated in FIG. 1 further includes a fine adjusting unit for the positions of the substrate supporting members 12. Further, although not illustrated, the alignment mechanism further includes a position adjusting unit for the positions of the mask supporting members 14 of FIG. 1.

By the way, the substrate 11 and the mask 13 are each provided with alignment marks (not shown) for alignment. The cameras 32 are located above the positions of the alignment marks in order to observe the alignment marks of the substrate 11 and the mask 13 during the alignment. The alignment between the substrate 11 and the mask 13 is performed by, as illustrated in FIG. 1, adjusting the relative positional relation of the alignment marks respectively formed on the substrate 11 and the mask 13 under the state in which the substrate 11 and the mask 13 are spaced apart from each other.

Note that, an available method for the alignment is as follows. The mask 13 is laid at a predetermined position and a substrate drive stage (not shown) is used to move the substrate 11, to thereby adjust the relative positional relation between the substrate 11 and the mask 13. Further, the method for the alignment may use another configuration in which the substrate 11 is laid at a predetermined position and a mask drive stage (not shown) is used to move the mask 13. Alternatively, a drive stage for moving both of the substrate 11 and the mask 13 may be provided.

For example, if the weight of the mask is larger than that of the substrate, alignment precision may be increased by moving the substrate. Further, by moving both of the substrate and the mask to adjust the relative positional relation therebetween, an alignment time may be shortened. As described above, which object is to be moved can be selected based on an arbitrary design depending on the form of the apparatus or the purpose of the apparatus.

Further, when a film of an organic material is to be formed on the substrate 11, the substrate 11 and the vapor depositing source 15 may each be located at a fixed position, or may be configured to be moved relatively. The vapor depositing source may be in the form of a single vapor depositing source or in the form of multiple arrayed vapor depositing sources. Further, although not illustrated, in the film forming chamber, a rate control sensor for the purpose of managing or controlling the rate of evaporation from the vapor depositing source may be disposed.

Further, in FIG. 1, in order that a surface of the substrate 11 on which the film is to be formed face downward, the mask 13 is disposed below the substrate 11. However, the arrangement of the mask 13 and the substrate is not limited thereto as long as a film forming material can be patterned on the surface of the substrate 11 on which the film is to be formed. For example, the substrate 11 and the mask 13 may be disposed upright, or alternatively the surface of the substrate 11 on which the film is to be formed may face upward. Note that, in the following drawings, the same reference symbols as those of FIG. 1 denote the same constituent elements as those of FIG. 1.

FIG. 2 is a cross-sectional view illustrating a second embodiment of the film forming apparatus according to the present invention. Referring to FIG. 2, in the film forming apparatus, a chamber for alignment between the substrate 11 and the mask 13 and a chamber for film formation may be separately provided and connected to each other as a multi-chamber. In this manner, the film forming chamber is separated into a chamber for alignment and a chamber for film formation, whereby a size of the chamber mounted an alignment mechanism can be reduced. As a result, amount of deformation caused by pressure difference of inside and outside of the chamber can be reduced. The degree of vacuum is preferably maintained to be 1×10⁻³ Pa or lower, more preferably 1×10⁻⁴ Pa or lower.

Next, the members constituting the supporting member 20 are described. As described above, the supporting member 20 is a member formed of the supporting plate 21 and the leg portions 22.

In the film formation apparatus of FIG. 1, the supporting plate 21 is provided to be spaced apart from a top board 10a of the film forming chamber via the leg portions 22. This configuration can reduce or block the transmittance of slight deformation, which is possibly generated in the film forming chamber 10, to the supporting member 20 and the alignment mechanism placed on the supporting member.

Further, from the following two reasons, it is possible to alleviate the vibration transmitted to the alignment mechanism placed on the supporting member 20. The first reason is that at least a part of the supporting plate 21 is formed of a damping material. The damping material as described herein means a material having damping properties, and is a material having a high damping capacity capable of converting the vibration transmitted to the support member from the outside into thermal energy so as to diffuse the thermal energy, thereby damping the vibration within a short period of time. Further, the phrase “at least a part of the supporting plate 21 is formed of a damping material” includes the form in which the whole supporting plate 21 is formed of a damping material and the form in which the supporting plate 21 is formed such that a plate formed of a damping material and a plate formed of another material are bonded to each other. As another example of the form, only a part of the supporting plate 21 on which the alignment mechanism is placed may be formed of a damping material.

Note that, it is desired that the supporting plate 21 described above be a rigid body which is not deformed by an external vibration. The second reason is that the leg portions are disposed in the vicinity of the periphery of the film forming chamber so that a mechanical vibration resistance can be provided as described later.

In this manner, it is possible to suppress or block the vibration inside the film formation apparatus accompanying the movement of the substrate, the operation of a robot, the opening/closing of a door valve, or the like as well as the vibration from outside the film formation apparatus caused by the influence of vibration generated by various kinds of equipment including an air exhauster, to thereby suppress or block the vibration transmitted to the alignment mechanism. As a result, an alignment error between the substrate and the mask can be reduced, and hence an organic EL element or an organic EL apparatus in which an organic compound layer is patterned with good dimensional precision can be manufactured.

Note that, the damping material constituting the supporting plate 21 can employ a known damping alloy. It is preferred to use cast iron (such as Fe—C—Si based alloy), which is easily applicable to a large-scale structure, or a damping alloy of a partial dislocation type with a large damping capacity (such as Mn—Cu—Ni—Fe based alloy), which utilizes the movement of twin crystal. Examples of the cast iron include gray cast iron, ductile cast iron, and invar cast iron, and the cast iron to be used can be appropriately selected therefrom. Other examples of the twin crystal type alloy than the Mn—Cu—Ni—Fe based alloy include an Mn—Cu—Al—Fe—Ni based alloy, a Cu—Zn—Al based alloy, and an Fe—Mn—Cr based alloy, and the damping alloy to be used can be appropriately selected therefrom. Note that, it is considered that, when vibration is applied to the cast iron, the vibration is converted into thermal energy by a friction between black lead and iron contained in the cast iron so that the vibration can be suppressed. Further, it is considered that, when vibration is applied to the partial dislocation type alloy, twin crystal having various sizes are formed in the alloy and kinetic energy is converted into thermal energy by the movement of twin crystal so that the vibration can be suppressed.

Next, the effect obtained by providing the leg portions 22 of the film formation apparatus of FIG. 1 in the vicinity of the periphery of the film forming chamber 10 is described in detail. A peripheral portion of the top board 10a of the film forming chamber 10 is supported by a wall surface (side wall) of the film forming chamber 10. Accordingly, the strength of the top board 10a in the vertical direction is stronger in the vicinity of the periphery of the top board 10a and weaker in the vicinity of the center of the top board 10a. Therefore, if a pressure difference is generated between inside and outside the film forming chamber 10, the top board 10a is more deformed in the vicinity of the central portion of the top board 10a and less deformed at the peripheral portion of the top board 10a. Further, the strength of the top board 10a is stronger toward the vicinity of the periphery of the top board 10a, and the periphery of the top board 10a is less affected by the vibration transmitted to the top board 10a, especially a vibration at low frequency. It is therefore possible to structurally reduce the risk that the vibration generated from the floor on which the film formation apparatus is installed and the vibration generated from inside the film forming chamber during the step of aligning the substrate 11 and the mask 13 or the vapor deposition step are directly transmitted to the support member 20 from the film forming chamber.

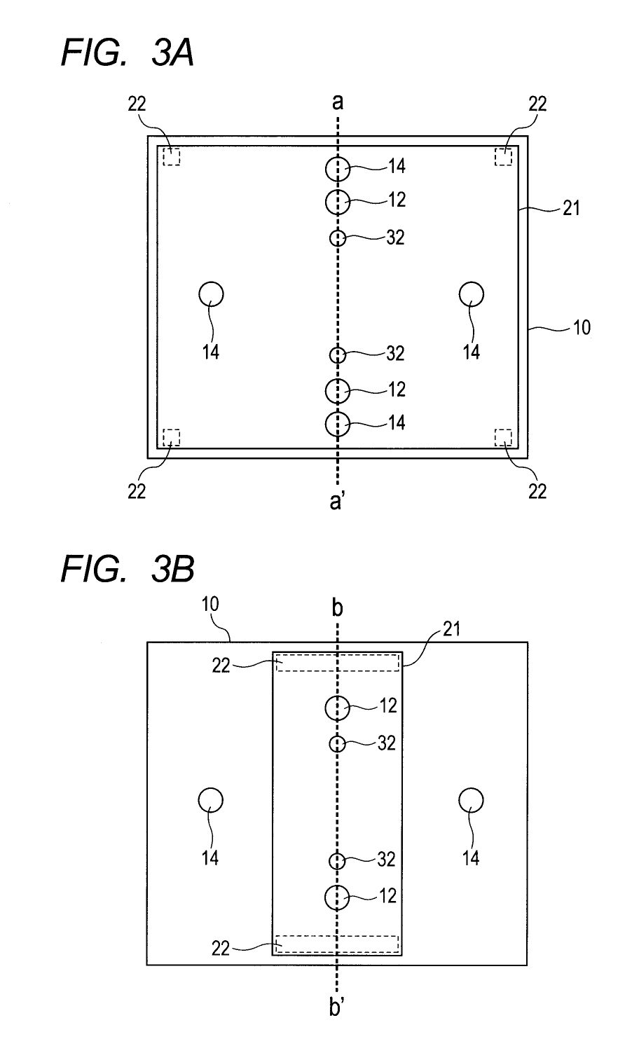

Note that, the position at which the leg portion is provided may be anywhere within a region corresponding to the vicinity of the periphery of the top board 10a as long as the supporting member 20 can be supported with no strength problem. For example, as illustrated in FIG. 3A of a schematic top view of the film formation apparatus, the leg portions 22 (delimited by the broken lines) may be placed at the respective corners of the top board 10a to support the supporting member 20. In FIG. 3A, the leg portions 22 are placed outside the mask supporting members 14 (on the wall surface side of the film formation apparatus 10). Note that, the broken line a-a′ indicates the center of the film formation apparatus. Further, as another form illustrated in FIG. 3B, the leg portions 22 may be disposed at the periphery of the film formation apparatus along the sides of the supporting plate. According to the form of the film formation apparatus illustrated in FIG. 3B, the cameras for alignment 32, the substrate supporting members 12, and the leg portions 22 are disposed in this order from the center of the film forming chamber 10 toward the periphery thereof along the broken line b-b′, which indicates the center of the film formation apparatus. In other words, the leg portions 22 are placed outside the substrate supporting members 12 (on the wall surface side of the film formation apparatus 10).

As described above, the leg portions of the supporting plate are disposed outside at least one of the member for supporting the mask and the member for supporting the substrate. This configuration can reduce or block the transmittance of slight deformation, which is possibly generated in the film forming chamber 10, or vibration to the supporting member 20 and the alignment mechanism placed on the supporting member.

Note that, in the film formation apparatus according to the present invention, the number and the arrangement of each of the substrate supporting members for supporting the substrate, the mask supporting members for supporting the mask, and the cameras for alignment are not limited to the ones described above. The number and the arrangement thereof can be arbitrarily determined based on the size or weight of the substrate, the size or weight of the mask, the number of the alignment marks, the layout positions of the alignment marks, and the like.

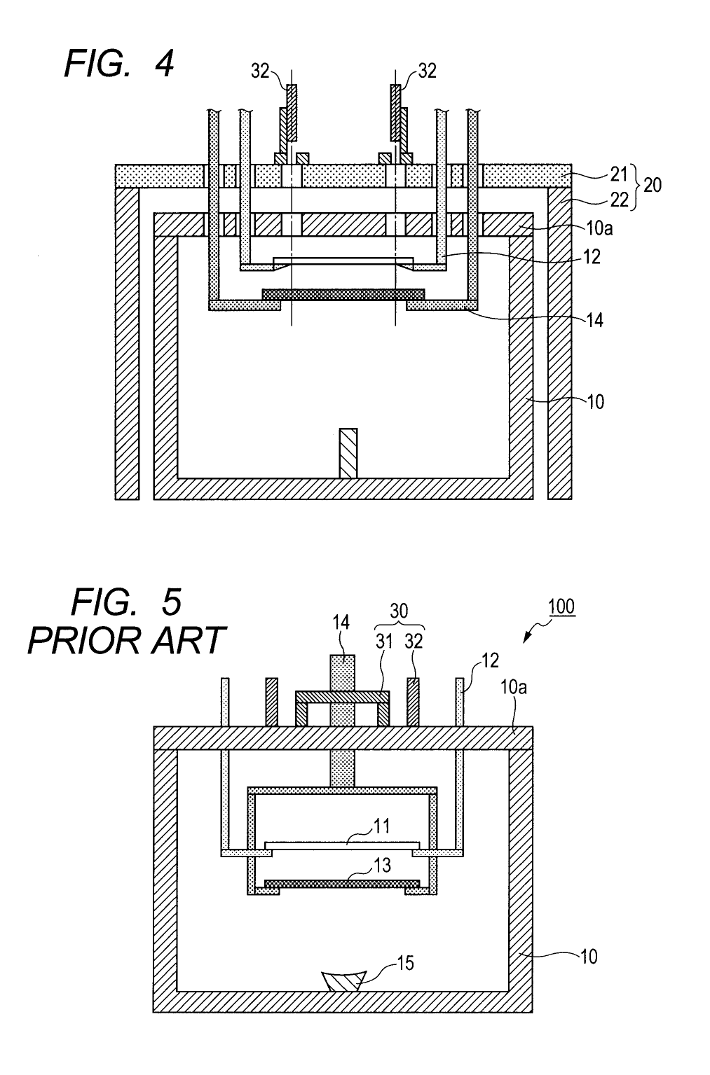

It is also preferred that, in the film formation apparatus according to the present invention, the supporting plate 21 be completely spaced apart from the top board 10a of the film forming chamber. FIG. 4 illustrates a schematic cross-sectional view illustrating a third embodiment of the film formation apparatus according to the present invention. As illustrated in FIG. 4, the leg portions 22 for supporting the supporting member 20 are provided at the positions away from the film forming chamber 10, more specifically, outside the side wall of the film forming chamber 10. With this configuration, the above-mentioned problem can also be solved.

Note that, although not illustrated in FIG. 4, a vibration insulating member may be provided at the lower end of each of the leg portions 22. The provision of the vibration insulating member at the lower end of each of the leg portions 22 can enhance the effect of alleviating the vibration transmitted to the alignment mechanism. Specifically, with the provision of the vibration insulating member, the vibration transmitted to the alignment mechanism from the floor on which the supporting member 20 is installed can be absorbed effectively by the vibration insulating member.

It is desired that the vibration insulating member have a function of preventing the alignment mechanism from resonating with the vibration transmitted from the outside. It is preferred that the vibration insulating member have a wide frequency region capable of alleviating the vibration. Further, the vibration insulating member can employ a hard porous ceramics, a high carbon cast iron, a hard porous ceramics or a high cast iron a side surface of which is covered with a rubber in order to cut off surface elastic vibration wave, or the like. The vibration insulating member is not limited thereto as long as the vibration insulating member can have a function of alleviating the vibration.

The above-mentioned vibration insulating member is applicable to the film formation apparatus according to the other embodiments. For example, in FIG. 1, the vibration insulating member can be provided at the lower end of each of the leg portions 22 placed in the region corresponding to the peripheral portion of the top board 10a. Also in this case, the same effect as that of the film formation apparatus of FIG. 4 can be obtained.

In the description above, the film formation apparatus typically applied to the vapor deposition apparatus has been described, but the present invention is similarly applicable to the film formation apparatus used for forming a protective film by CVD.

Hereinafter, the present invention is described in Examples.

### Example 1

The film formation apparatus illustrated in FIG.

1 was used to manufacture an organic EL element on a glass substrate. First, a known light emitting material was placed in the vapor depositing source 15. In the film forming chamber 10, the substrate 11 was located with the surface, on which the film was to be formed, being oriented so as to face downward.

In this example, the glass substrate made of non-alkali glass with a thickness of 0.5 mm and dimensions of 400 mm×500 mm was used as the substrate 11. Note that, on the substrate, thin-film transistors (TFTs) and electrode wirings were formed in a matrix pattern by a conventional method. Further, the size of each pixel was 30 μm×120 μm. A formation region of the organic EL element was formed to have dimensions of 350 mm×450 mm. Meanwhile, in this example, the mask 13 used was obtained by applying a tension to the mask portion having a thickness of 40 μm and dimensions of 400 mm×500 mm and welding the mask portion to the frame member having a thickness of 20 mm. The mask obtained by thus integrating the mask portion to the frame member was used. Note that, the invar material was used as a material of the mask portion and the frame member.

The supporting member 20 was placed on the film forming chamber 10. On the supporting plate 21, the alignment mechanism including the cameras 32 and the position adjusting unit (not shown) for the substrate supporting members 12 was placed. The supporting plate 21 was manufactured by gray iron (FC250) as a damping alloy.

Further, the leg portions of the supporting plate were provided at the four corners on the periphery of the top board of the film formation apparatus 10. Note that, the height of the leg portions for spacing the supporting plate 21 and the top board 10a from each other was set to 10 mm.

Next, a step of fabricating an organic EL element is described.

First, anode electrodes were formed on the glass substrate including the TFTs so as to have a light emitting region of 10 μm×90 μm (about 25% of pixel aperture ratio). When a width of the non-light emitting portion provided between adjacent and different color light emitting pixels is 20 μm, the required precision of alignment for the element having the above-mentioned light emitting region is ±10 μm.

Next, by using the above-mentioned film formation apparatus and the above-mentioned vapor deposition mask, the substrate supporting members provided to the alignment mechanism were lowered in a vacuum state to bring the substrate 11 and the mask 13 closer to each other to have a distance of 0.4 mm therebetween. Next, the substrate supporting members 12 supporting the substrate 11 were operated while monitoring the alignment marks provided on the substrate 11 and the alignment marks provided on the mask 13 by using CCD cameras (cameras 32), to thereby align the substrate 11 and the mask 13 with each other. After the alignment was completed with predetermined alignment precision, the substrate supporting members 12 were further lowered to bring the substrate 11 into contact to the mask 13. Immediately after the substrate 11 was brought into contact to the mask 13, the CCD cameras (cameras 32) were used to check the alignment precision again. After the alignment precision was confirmed to satisfy predetermined precision, the substrate supporting members 12 were separated away from the substrate 11, and the substrate 11 was placed on the mask 13. Note that, in the alignment operation period, the up-and-down movement of the substrate supporting members 12 and the operation of contact between the substrate and the mask were performed. However, before and after the respective operations, the relative positions of the alignment marks of the substrate 11 and the mask 13 identified by the cameras 32 were accurate enough not to hinder the predetermined alignment precision.

Next, a film was formed of a known light emitting material to have a thickness of 700 Å by using a vacuum vapor deposition method at a vapor-depositing rate of 3 Å per second under a condition that the degree of vacuum was 2×10⁻⁴ Pa while moving the vapor depositing source relative to the substrate. The vapor-depositing rate was continued to be monitored on a rate monitor (not shown) and fed back to a heating control portion of the vapor depositing source as necessary so as to perform the vapor deposition at a stable rate.

After the film formation, the shape of the film formed on the substrate was checked. Then, the shape was almost the same as the size of the aperture of the mask. Further, it was found that the formed film was appropriately located on the anode electrode. The state in which the formed film was appropriately located as described herein means that the alignment precision immediately before the film formation is almost the same as the positional precision of the formed film.

As described above, it was found that, by using the film formation apparatus according to this example, an organic EL element in which an organic compound layer is patterned with good dimensional precision can be manufactured.

### Example 2

The film formation apparatus illustrated in FIG. 4 was used to manufacture an organic EL element on a glass substrate.

The supporting member 20 was placed so as to cover and surround the film forming chamber 10 in a U-shaped manner. In this case, the leg portions 22 provided with a vibration insulating member 23 constituted by cast iron and provided at the lower end of each of the leg portions 22 were placed on the floor. Further, on the supporting member 20, the alignment mechanism 30 including the cameras 32, the position adjusting unit of the mask supporting member 12 (not shown), and the position adjusting unit (not shown) for the substrate supporting members was placed.

Further, the members other than the above-mentioned leg portion 22, the mask, the substrate, and the film formation conditions were the same as those of Example 1.

Next, as in Example 1, a film was formed of a known light emitting material to have a thickness of 700 Å by using a vacuum vapor deposition method at a vapor-depositing rate of 3 A per second under a condition that the degree of vacuum was 2×10⁻⁴ Pa.

After the film formation, the shape of the film formed on the substrate was checked. Then, the shape was almost the same as the size of the aperture of the mask. Further, it was found that the formed film was appropriately located on the anode electrode. As described above, it was found that, by using the film formation apparatus according to this example, an organic EL element in which an organic EL layer is patterned with good dimensional precision can be manufactured.

### Comparative Example 1

The film formation apparatus illustrated in FIG. 5 was used to manufacture an organic EL element on a glass substrate. In the film formation apparatus 100 of FIG. 5, the alignment mechanism 30 including the cameras 32, the position adjusting unit of the mask supporting member 12 (not shown), and the position adjusting unit (not shown) for the substrate supporting members was directly provided on the top board 10a of the film forming chamber. The other conditions for the used mask and substrate were the same as those of Example 1.

As in Example 1, anode electrodes were formed on the glass substrate including the TFTs. By using the above-mentioned film formation apparatus and a known vapor deposition mask, the alignment mechanism 30 was operated in a vacuum state to bring the substrate 11 and the mask 13 closer to each other to have a distance of 0.1 mm therebetween. Next, the mask 13 was operated by the alignment mechanism to align the substrate 11 and the mask 13 with each other while monitoring the alignment marks provided on the substrate and the alignment marks provided on the mask by using CCD cameras 32. After the alignment between the substrate 11 and the mask 13, the mask was operated by the alignment mechanism to bring the substrate 11 into contact with the mask 13.

Next, a film was formed of a known light emitting material to have a thickness of 700 Å by using a vacuum vapor deposition method at a vapor-depositing rate of 3 Å per second under a condition that the degree of vacuum was 2×10⁻⁴ Pa.

After the film formation, the shape of the film formed on the substrate was checked. Then, the shape was larger than the size of the aperture of the mask, and a blur in the formed film was recognized. Further, it was found that the formed film was disposed out of alignment with the position of the anode electrode and the formed film was not appropriately located.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-153692, filed Jul. 6, 2010, and 2011-126928, filed Jun. 7, 2011, which are hereby incorporated by reference herein in their entirety.

What is claimed is:

1. A film formation apparatus, comprising:
a film forming chamber provided with a substrate supporting member and a mask supporting member in the film forming chamber;
a supporting member provided outside the film forming chamber; and
an alignment mechanism provided on the supporting member and provided with at least one of a position adjusting unit for the substrate supporting member and a position adjusting unit for the mask supporting member, and a camera for alignment, wherein:
the supporting member includes a supporting plate for placing the alignment mechanism, and a leg portion;
the supporting plate is provided so as to be spaced apart from a top board of the film forming chamber via the leg portion; and
at least a part of the supporting plate is formed of a damping material capable of converting vibration transmitted to the supporting plate into thermal energy, thereby suppressing the vibration.

2. The film formation apparatus according to claim 1, wherein the damping material contains a damping alloy capable of converting friction energy generated between components contained in the damping material into thermal energy.

3. The film formation apparatus according to claim 1, wherein the damping material contains a damping alloy capable of converting kinetic energy accompanying generation of twin crystal and movement of the twin crystal into thermal energy.

4. The film formation apparatus according to claim 1, wherein the leg portion is provided in a region outside at least one of a periphery of the mask supporting member and a periphery of the substrate supporting member.

5. The film formation apparatus according to claim 1, wherein the leg portion is provided outside at least one of a periphery of the mask supporting member and a periphery of the substrate supporting member, and inside a side wall of the film forming chamber.

6. The film formation apparatus according to claim 1, wherein the leg portion is provided outside a side wall of the film forming chamber.

7. The film formation apparatus according to claim 1, wherein the leg portion includes a vibration insulating member.

8. The film formation apparatus according to claim 7, wherein the vibration insulating member is formed of the damping material
